(19) United States
(12) Patent Application Publication
(10) Pub. No.: US 2010/0225827 A1
(43) Pub. Date: Sep. 9, 2010

(54) APPARATUS AND METHOD FOR DISPLAYING IMAGE

(76) Inventors: Kun Sik Lee, Gyeonggi-do (KR); Uni Young Kim, Gyeonggi-do (KR); Youn Jine Cha, Gyeonggi-do (KR); Jin Kim, Gyeonggi-do (KR); Jae Hee Shim, Gyeonggi-do (KR)

Correspondence Address: KED & ASSOCIATES, LLP, P.O. Box 221200, Chantilly, VA, 20153-1200, US

(21) Appl. No.: 12/670,344

(22) PCT Filed: Nov. 15, 2007
(86) PCT No.: PCT/KR07/05742

§ 371 Date: Jan. 22, 2010

(30) Foreign Application Priority Data
Jul. 26, 2007 (KR) 10-2007-0075172

(51) Int. Cl. H04N 5/455; H04N 5/445

(52) U.S. Cl. 348/726; 725/39; 348/E05.113

(57) ABSTRACT

Provided is an image display apparatus. The apparatus includes a tuner, a demodulator, a demultiplexer, a controller, an OSD controller, a graphic driver, and an OSD displayer. The tuner receives broadcasting signals, the demodulator demodulates signals of a channel selected by the tuner, and the demultiplexer demultiplexes signals demodulated by the demodulator into audio signals, video signals, and a PSIP table. The controller controls information of an electronic program guide extracted from the demultiplexed data to be output in the form of an on-screen-display, and divides the electronic program guide into a text region and a background region to set gradation on the background region of the electronic program guide. The OSD controller performs a gradation process with respect to the background region of the electronic program guide using a gradation value set by the controller. The graphic driver allows the electronic program guide on which the gradation process is performed by the on-screen-display controller to be displayed as an image in the form of the on-screen-display. The on-screen-display displayer displays the on-screen-display representing the electronic program guide delivered from the graphic driver on a screen together with decoded image signals.

### TECHNICAL FIELD

The present embodiments relate to an apparatus and a method for displaying an image, that displays electronic program guide (EPG) information.

### BACKGROUND ART

Generally, digital broadcasting service includes audio/video (A/V) broadcasting service, and data broadcasting service.

An EPG is displayed on a screen using the data broadcasting service to induce a user to actively view broadcasting.

Data such as the EPG are displayed on a screen in the form of an on-screen-display (OSD).

### DISCLOSURE OF INVENTION

### Technical Problem

Embodiments provide an apparatus and a method for displaying an image that improve a screen of an EPG displayed by the apparatus for displaying the image to enhance a viewing environment of a user.

### Technical Solution

In one embodiment, an image display apparatus includes: a tuner for receiving broadcasting signals; a demodulator for demodulating signals of a channel selected by the tuner; a demultiplexer for demultiplexing signals demodulated by the demodulator into audio signals, video signals, and a program and system information protocol (PSIP) table; a controller for controlling information of an electronic program guide extracted from demultiplexed data to be output in the form of an on-screen-display, and dividing the electronic program guide into a text region and a background region to set gradation with respect to the background region of the electronic program guide; an on-screen-display controller for performing a gradation process on the background region of the electronic program guide using a gradation value set by the controller; a graphic driver for allowing the electronic program guide on which the gradation process is performed by the on-screen-display controller to be displayed as an image in the form of the on-screen-display; and an on-screen-display displayer for displaying the on-screen-display representing the electronic program guide delivered from the graphic driver on a screen together with decoded image signals.

In another embodiment, an image display method includes: parsing information of an electronic program guide from demultiplexed data; dividing the information of the electronic program guide into a text region and a background region to generate an on-screen-display regarding the electronic program guide; dividing the background region of the electronic program guide into a plurality of regions; setting a color value to each of the plurality of regions forming the background region of the electronic program guide to perform gradation on the background region of the electronic program guide; and generating an on-screen-display according to the set color value to output the on-screen-display together with decoded image signals on a screen.

The details of one or more embodiments are set forth in the accompanying drawings and the description below. Other features will be apparent from the description and drawings, and from the claims.

### Advantageous Effects

According to an embodiment, an on-screen-display of an electronic program guide serving as a user interface is processed in the form of gradation to provide a user with more convenient user environment.

### BRIEF DESCRIPTION OF THE DRAWINGS

FIG. 1 is a block diagram explaining an image display apparatus according to an embodiment.

FIG. 2 is a flowchart explaining an image display method according to an embodiment.

FIG. 3 is an exemplary EPG screen illustrating a background region of an EPG is divided into a plurality of regions according to an embodiment.

FIGS. 4 to 7 are photos illustrating an EPG processed in the form of gradation according to an embodiment.

### MODE FOR THE INVENTION

Reference will now be made in detail to the embodiments of the present disclosure, examples of which are illustrated in the accompanying drawings.

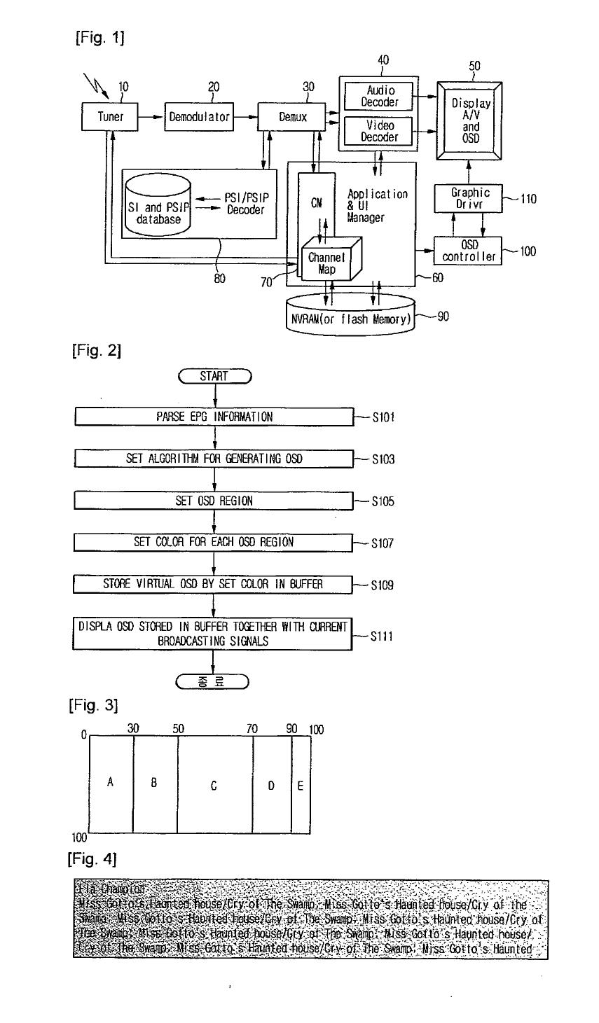

FIG. 1 is a block diagram explaining an image display apparatus according to an embodiment.

Referring to FIG. 1, the image display apparatus includes a tuner 10, a demodulator 20, a demultiplexer 30, and a decoder 40. The tuner 10 receives transmitted broadcasting signals and tunes and outputs signals of a predetermined channel selected by a user. The demodulator 20 demodulates the signals of the channel selected by the tuner 10. The demultiplexer 30 demultiplexes the demodulated signals into audio signals, video signals, digital video broadcasting-system information (DVB-SI) and a program and system information protocol (PSIP) table. The audio/video decoder 40 decodes the demultiplexed signals.

Also, the audio/video decoder 40 includes an audio decoder for decoding and outputting the audio signals of the demultiplexed signals, and a video decoder for decoding and outputting the video signals of the demultiplexed signals.

Also, the image display apparatus includes a PSI/PSIP decoder 80 for decoding a PSI table or a PSIP table, an SI/PSIP database for storing decoded results, and an application and user interface manager 60 including a channel manager for channel management.

Data obtained by demultiplexing the PSIP table includes EPG information. The EPG information is generated as an on-screen-display (OSD) by the application and user interface manager 60.

Since the application and user interface manager 60 performs a control operation for allowing received EPG information to be output in the form of an OSD in the image display apparatus, the application and user interface manager 60 is briefly referred to as a controller hereinafter.

Also, depending on embodiment, the image display apparatus includes an OSD controller 100 for performing gradation on the color of an EPG displayed in the form of OSD, and a graphic driver 110 for displaying an image on which the gradation has been performed by the OSD controller 100. An operation between the controller 60 and the OSD controller 100 will be described below in detail.

Also, descriptions of elements of the image display apparatus will be made when the operation of the image display apparatus is described.

A block diagram of the image display apparatus for receiving a channel and an event extended text table (ETT) is illustrated. The tuner 10 receives sky waves or cable digital television (DTV) signals through an antenna under control of a channel manager 70. That is, the tuner 10 reports the result and strength of signals being received to the channel manager 70, and transmits received signals to the demodulator 20.

In the case where sky wave broadcasting is received, the demodulator 20 performs 64 or 256 vestigial side band (VSB) demodulation. In the case where cable broadcasting is received, the demodulator 20 performs 64 or 256 quadrature amplitude modulation (QAM) demodulation. Also, the demodulator 20 transmits demodulated signals to the demultiplexer 30. Also, the embodiment can be come into operation in various demodulations.

The demultiplexer 30 demultiplexes audio packets, video packets, PSI/PSIP tables, and data broadcasting related tables from input transmission packets to filter the same from the packets.

At this point, while demultiplexing the tables, the demultiplexer 30 is controlled by the PSI/PSIP decoder 80 and a data broadcasting decoder. That is, the demultiplexer 30 examines a header section that is common to the tables under control of the PSI/PSIP decoder 80 and the data broadcasting decoder.

Also, the demultiplexer 30 makes the section of the PSI/PSIP table for audio/video (A/V) broadcasting service, and transmits the made section to the PSI/PSIP decoder 80.

Also, while demultiplexing audio/video transmission packets, the demultiplexer 30 is controlled by the channel manager 70. That is, when audio/video packet identification (ID) of a relevant virtual channel is set, the demultiplexer 30 demultiplexes basic streams of the audio/video packets and then transmits the demultiplexed streams to the audio/video decoders 40, respectively.

Also, decoded audio/video data are transmitted to an output unit, i.e., an A/V and on-screen-display (OSD) displayer 50 so that the audio/video data are synchronized and displayed by a video display processor (VDP).

The A/V and OSD displayer 50 receives audio/video data decoded by the audio/video decoder 40. The A/V and OSD displayer 50 (referred to as an OSD displayer hereinafter) outputs the received audio/video data through a speaker and a screen, respectively. At this point, when displaying information of an EPG on the screen, the OSD displayer 50 is controlled by the graphic driver 110.

The controller 60 receives a key input by a user viewing the image display apparatus, and responses to a user request through a graphic user interface on the screen of the image display apparatus. Also, the controller 60 receives A/V data from the A/V decoder 40 and controls the OSD displayer to display the A/V data in the form of an OSD. The controller 60 manages an application status and a database, and manages and controls an OSD related to data broadcasting.

Also, the controller 60 controls the channel manager 70 to perform a channel related operation (channel map management and PSI/PSIP decoder operation). Also, the controller 60 stores and recovers an entire GUI control of the image display apparatus, a user request, and an apparatus status in and from a non volatile random access memory (NVRAM) 90 (or flash memory).

Meanwhile, a structure in which an EPG output by the OSD displayer 50 in the form of an OSD together with current broadcasting signals will be described in detail. That is, the roles of the controller 60, the OSD controller 100, and the graphic driver 110 will be described in more detail.

Particularly, while image signals obtained by decoding current broadcasting signals are displayed on the screen of the image display apparatus, the background region of the EPG output in the form of the OSD has various brightness, opacities, and hues due to gradation of color.

Gradation is used as a term describing an embodiment. The gradation means changing brightness or opacity of color having the brightness and opacity. The gradation also means arranging colors of different hues.

Since the construction of receiving the information of the EPG through the tuner and parsing the same can be known through the previous embodiment and existing known technology, detailed description thereof is omitted, and the EPG is defined as the text region and the background region excluding the text region when the EPG is displayed in the form of an OSD.

That is, FIGS. 4 to 7 illustrate examples where various descriptions of brightness, opacity, and hue are applied to the background region of the EPG. Characters (or symbols) expressing information of broadcasting/channel/recording in the EPG displayed in the form of an OSD may be defined as the text region. The other region of the EPG excluding the text region is defined as the background region.

For reference, the EPG displayed in the form of an OSD is divided into the text region and the background region, but images such as emoticons and icons not mentioned are separately stored in an internal memory. Accordingly, a relevant icon can be called and displayed on the OSD when needed.

A method for displaying an EPG on the screen, and a construction thereof are described with reference to FIGS. 1 to 3.

Information of an EPG is parsed from broadcasting signals received from an EPG manager (S101). The controller 60 sets an algorithm for generating an OSD to output the information of the EPG in the form of the OSD (S103). Here, the algorithm is designed for the controller 60 to perform an operation for generating the OSD.

After that, the controller 60 discriminates a text region and a background region from parsed EPG information, and divides and sets the background region of the EPG to a plurality of regions (S105).

Also, values of brightness, opacity, and hue are determined for the background region of the EPG to be output (S107).

In detail, the background region of the EPG to be output is illustrated in FIG. 3, in which the background region of the EPG may be divided into five regions(at least two regions).

For example, the controller 60 sets coordinates of an entire size with respect to the background region of the EPG to be output in the form of an OSD, and divides the background region of the EPG into five regions(at least two regions) of A, B, C, D, and E using the set coordinates.

Also, the controller 60 sets a value of color, a value of brightness of the color, and a value of opacity to be applied to each of the A to E regions.

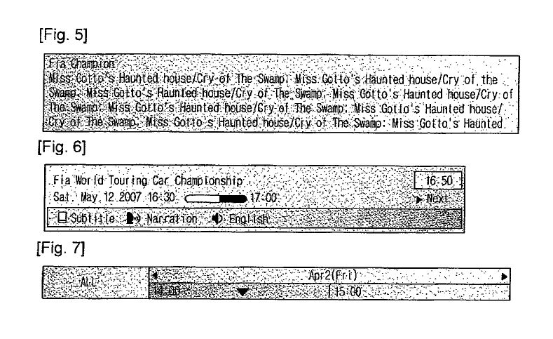

FIG. 4 illustrates a case where a brightness value and an opacity value are differently applied to each background region using one color, and FIG. 5 illustrates a case where a brightness value and an opacity value can be differently applied to each background region using a plurality of colors.

That is, the controller 60 divides the background region of an EPG to be output in the form of an OSD into a plurality of regions, and sets a color, a brightness value and an opacity value thereof for each divided region.

Here, all of brightness, color, and opacity do not need to be differently applied for the background region of an EPG divided into a plurality of regions, color, brightness, and opacity set by a user can be individually applied, of course.

For this purpose, a user operates a remote control unit of the image display apparatus to set the color, brightness, and opacity values of the background region of the EPG display in the form of the OSD.

Gradation of the A to E regions may be exemplarily described using brightness, opacity, and color values. Also, the brightness, opacity, and color are defined as color elements forming the gradation.

### Embodiment 1

Referring to FIG. 4, set values for expressing the background region of the EPG to which a plurality of brightness and opacity have been applied for a single color are described below.

Each region forming the background region of the EPG can be expressed using Rect (x, y, w, h). Here, x and y are coordinates representing the size of the background region of the EPG, and w and h may be the number of pixels or a width and height of EPG.

Also, a region A can be expressed by MARGB (100, 255, 0,0), a region B by MARGB (80, 255, 0, 0), a region C by MARGB (50, 255, 0, 0), a region D by MARGB (30, 255, 0, 0), and a region E by MARGB (0, 255, 0, 0). Here, M is a function representing color information, A is an opacity value, and each RGB is expressed by 32 bits representing color.

### Embodiment 2

Referring to FIG. 5, in the case where brightness and opacity are differently applied to the background region of an EPG using a plurality of colors, following values can be exemplarily applied to regions A to E.

A=MARGB(100,0,0,255), B=MARGB(100,0,0,200), C=MARGB(70,0,100,150), D=MARGB(100,0,255,0), E=MARGB(50,0,200,0)

After that, dividing the background region of an EPG, and setting a color are performed by the controller 60, and then a process for generating the EPG in the form of an OSD according to the set color is performed by the OSD controller 100 connected to the controller 60.

In detail, the OSD controller 100 converts a gradation value (values of brightness, opacity, and color) set by the controller 60 into a 32-bit value, and finds a color value corresponding to the converted 32-bit color value from a color palette set in advance to map the gradation value to the found color value.

Also, the OSD controller 100 sets a designated color value to a relevant region to store a virtual OSD in an internal buffer of the OSD controller 100 (S109). Also, the graphic driver 110 reads a value from the buffer storing the virtual OSD to perform a drawing operation so that an image is actually shown. The OSD displayer 50 allows the OSD drawn by the graphic driver 110 to be displayed together with current broadcasting signals (S111).

By doing so, as illustrated in FIGS. 4 to 7, the background region of the EPG can be processed to have gradation. Performing gradation on the EPG can be considered to considerably enhance esthetic feeling of a user because the EPG is a user interface.

For reference, FIG. 6 is a photo illustrating gradation of an EPG where only opacity has changed, and FIG. 7 is a photo illustrating gradation of an EPG where brightness and color have changed.

As described above, according to the embodiment, gradation is performed on the background region of the EPG in outputting an EPG displayed as a user interface in the form of an OSD, so that various tastes of a user can be satisfied by various expression of color.

### INDUSTRIAL APPLICABILITY

The embodiment can be implemented through a digital TV for receiving current digital broadcasting. Therefore, there is industrial applicability.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An image display apparatus comprising:
a tuner for receiving broadcasting signals;
a demodulator for demodulating signals of a channel selected by the tuner;
a demultiplexer for demultiplexing signals demodulated by the demodulator into audio signals, video signals, and a program and system information protocol (PSIP) table;
a controller for controlling information of an electronic program guide extracted from demultiplexed data to be output in the form of an on-screen-display, and dividing the electronic program guide into a text region and a background region to set gradation on the background region of the electronic program guide;
an on-screen-display controller for performing a gradation process on the background region of the electronic program guide using a gradation value set by the controller;
a graphic driver for allowing the electronic program guide on which the gradation process is performed by the on-screen-display controller to be displayed as an image in the form of the on-screen-display; and
an on-screen-display displayer for displaying the on-screen-display representing the electronic program guide delivered from the graphic driver on a screen together with decoded image signals.

2. The image display apparatus according to claim 1, wherein the controller divides the electronic program guide into a text region including characters or symbols, and a background region excluding the text region, divides the background region of the electronic program guide into a plurality of regions, and performs gradation on each divided region.

3. The image display apparatus according to claim 2, wherein the controller controls gradation processes having a different value to be performed on the plurality of regions, respectively.

4. The image display apparatus according to claim 2, wherein the gradation performed on the divided regions of the background region by the controller is performed such that at least one of hues, brightness and opacities of the divided regions is differently set.

5. The image display apparatus according to claim 1, wherein the gradation performed on the divided regions of the background region by the controller is performed by applying at least one of colors, brightness and opacities set by a user.

6. An image display method comprising:
parsing information of an electronic program guide from demultiplexed data;
dividing the information of the electronic program guide into a text region and a background region to generate an on-screen-display regarding the electronic program guide;
dividing the background region of the electronic program guide into a plurality of regions;
setting a gradation value to each of the plurality of regions forming the background region of the electronic program guide to perform gradation on the background region of the electronic program guide; and
generating an on-screen-display according to the set gradation value to output the on-screen-display together with decoded image signals on a screen.

7. The image display method according to claim 6, wherein the setting of the gradation value to each of the plurality of regions comprises setting at least one of brightness, hue and opacity values of the color.

8. The image display method according to claim 6, wherein gradation processes different from one another are performed on the plurality of divided regions, respectively.

9. The image display method according to claim 6, wherein the setting of the gradation value to each of the plurality of regions is performed according to at least one of brightness, hue and opacity values set in advance by a user.
